(19) United States
(12) Patent Application Publication
(10) Pub. No.: US 2012/0045657 A1
(43) Pub. Date: Feb. 23, 2012

(54) Metal-Ceramic Substrate

(75) Inventors: Jürgen Schulz-Harder, Lauf (DE); Lars Müller, Numberg (DE)

(73) Assignee: CURAMIK ELECTRONICS GMBH, Eschenbach (DE)

(21) Appl. No.: 13/258,852

(22) PCT Filed: Mar. 26, 2010
(86) PCT No.: PCT/DE2010/000347

§ 371 Date: Oct. 31, 2011

(30) Foreign Application Priority Data
Apr. 2, 2009 (DE) 10 2009 015 520.1

(51) Int. Cl. C04B 37/02; B32B 15/04; B23K 31/02; B32B 7/02; B32B 37/14; B23K 1/19; B32B 18/00; B32B 15/20

(52) U.S. Cl. 428/623; 428/446; 428/448; 428/213; 428/336; 428/337; 428/332; 428/220; 156/306.6; 228/124.5; 228/124.1

(57) ABSTRACT

A metal/ceramic substrate made up of a multilayer, plate-shaped ceramic material and at least one metallization provided on a surface side of the ceramic material. The at least one metallization is bonded to the ceramic material by direct copper bonding or reactive brazing and the ceramic material is made of a base layer made of silicon nitride ceramic. The at least one metallization is formed from at least one intermediate layer of an oxidic ceramic applied to the at least one base layer.

### BACKGROUND OF THE INVENTION

The invention relates to a metal/ceramic substrate made up of a multilayer, plate shaped ceramic material and at least one metallization provided on a surface of the ceramic material. Also provided is a method of making the multilayer, plate shaped ceramic material.

Metal/ceramic substrates or ceramic substrates with metallizations are known in a wide variety of designs, including, in particular, as printed circuit boards or substrates for electrical and electronic circuits or modules and, in this case, particularly for high-power circuits or modules.

Also known is the so-called DCB process for direct bonding the metallization forming strip conductors, connectors, etc. on a ceramic substrate, e.g. on an aluminium oxide ceramic substrate. In this process, which is described for example in U.S. Pat. No. 3,744,120 or in U.S. DE Pat. No. 2,319,854, metal layers or foils, e.g. copper layers or foils, are provided on their surface sides with a coating of a chemical compound of the metal (e.g. copper) and a reactive gas (preferably oxygen). This coating forms a eutectic (melted-on layer) with a thin layer of the adjacent metal, said eutectic having a melting point below the melting point of the metal (e.g. copper), so that by placing the metal layer or foil on the ceramic and heating all the layers, they can be bonded together by basically melting the metal only in the area of the melted-on layer or oxide layer. When copper or a copper alloy is used as the metal, this process is referred to as DCB bonding or a DCB (direct copper bonding) method.

This DCB method includes the following process steps, for example:
oxidising copper foil in such a manner that a uniform copper layer is produced;
placing the copper foil on the ceramic layer;
heating the composite to a process temperature between roughly 1025° C. and 1083° C., for example to roughly 1071° C.;
cooling to room temperature.

The aforementioned reactive brazing method for bonding metal layers or metal foils forming metallizations, particularly also copper layers or copper foils, to the ceramic material in each case is also known (DE 22 13 115; EP-A-153 618). With this method, which is also particularly used for the production of metal/ceramic substrates, a bond between a metal foil, a copper foil for example, and a ceramic substrate, an aluminium nitride ceramic for example, is produced at a temperature between roughly 800-1000° C. using brazing solder, which also contains an active metal in addition to a main component, such as copper, silver and/or gold. This active metal, which is at least an element of the group Hf, Ti, Zr, Nb, Ce, for example, creates a bond between the solder and the ceramic by means of a chemical reaction, while the bond between the solder and the metal is a metal brazed joint.

Also known is a metal/ceramic substrate with an inner layer or base layer made of a silicon nitride ceramic (EP 798 781), which exhibits significantly greater mechanical strength compared with an aluminium oxide ceramic (Al₂O₃ ceramic). To enable metallizations to be applied using the DCB method, it was proposed that an intermediate layer made of a pure aluminium oxide ceramic should be applied to the base layer of silicon nitride ceramic in each case. However, this process does not produce a complete bond, particularly not a defect-free bond, between the ceramic material and the metallization. Instead, numerous gas bubbles also occur between the metallization and the ceramic material, particularly when using copper metallizations, said bubbles being caused by a reaction between the oxygen from the copper or copper oxide eutectic (Cu/Cu₂O eutectic) and the silicon nitride ceramic, namely according to the following formula:

6 CuO+Si₃N₄→3 SiO₂+6 Cu+N₂.

This reaction means, on the one hand, that the liquid eutectic Cu/Cu₂ phase required for bonding is used or totally consumed. On the other hand, the resulting gaseous nitrogen (N₂) causes bubbles to form. This detrimental reaction cannot be prevented by the intermediate layer of pure aluminium oxide ceramic. According to the know-how on which the present invention is based, this is due, among other things, to the very different thermal expansion coefficients of silicon nitride (3.0×10⁻⁶ K⁻¹) and aluminium oxide (8×10⁻⁶ K⁻¹). These differences in the thermal expansion coefficient lead to cracks forming in the intermediate layer, e.g. during the burning or sintering of the intermediate layer of aluminium oxide ceramic, but also during the bonding of the metallizations (DCB method), so that the above reaction between the Cu/Cu₂O eutectic and the silicon nitride ceramic can take place through these cracks.

Furthermore, it is known (EP 0 499 589) to provide at least one intermediate layer made of pure silicon oxide (SiO₂) and then to apply the metallization using the DCB method. This procedure does not produce a useable result either, as the eutectic melt required for the DCB method reacts with the SiO₂ to create liquid Cu₂O—SiO₂. An intermediate layer of SiO₂ cannot therefore be used for the application of metallisations using the DCB method.

The problem addressed by the invention is that of producing a metal/ceramic substrate that avoids the aforementioned disadvantages while retaining the fundamental benefits of the silicon nitride ceramic.

### SUMMARY OF THE INVENTION

Zirconium oxide and/or a silicate, particularly a zirconium-silicate (ZrSiO₄) and/or a titanium silicate and/or a hafnium silicate are particularly suitable for the intermediate layer.

The silicon nitride ceramic forming the base layer and/or the intermediate layer—possibly in addition to sintering additives (e.g. rare earth elements)—also preferably have oxidic components, such as LiO₂, TiO₂, BaO, ZnO, B₂O₃, C₅O, Fe₂O₃, ZrO₂, CuO, Cu₂O, for example. Combinations of at least two of these components may also be used as additional oxidic components, in which case the proportion of these additional oxidic components is maximum 20% by wt. relative to the total mass of the intermediate layer. With this additional oxidic component, the properties of the intermediate layer, among other things, can be specifically controlled or adjusted in relation to the softening point. Furthermore, reactions of the copper oxide (particularly Cu₂O) during the DCB process can also be suppressed with this additional component, which could result in fusible reaction products. These rare earth elements in the intermediate layer may also be present due to diffusion from the silicon nitride ceramic base layer during the burning of the intermediate layer.

The substrate according to the invention exhibits a high adhesion or peel strength of the metallization on the ceramic material. A further significant advantage of the substrate according to the invention is that the intermediate layer has a modulus of elasticity of under 300 GPa, so that an optimum balance of the very different thermal coefficients of expansion in the silicon nitride ceramic and the metal (e.g. copper) of the metallizations is achieved, namely in contrast with the relatively high modulus of elasticity of 390 GPa for aluminium oxide.

The low modulus of elasticity of the intermediate layer means, in particular, that very thick metallizations are possible, namely up to three times the thickness of the base layer made of silicon nitride ceramic.

In a further development of the invention, the substrate is designed in such a manner, for example,

that the silicate in the silicate layer is a zirconium silicate, a titanium silicate and/or a hafnium silicate,

and/or

that the at least one intermediate layer has a thermal coefficient of expansion that is smaller than or, at most, equal to 6×10⁻⁶K⁻¹,

and/or

that the proportion of free silicon oxide (SiO₂) in the at least one intermediate layer is negligibly small, at least close to the bond between the intermediate layer and the metallization,

and/or

that the proportion of free silicon oxide in the at least one intermediate layer is equal to or close to zero, at least in the area of the bond between the intermediate layer and the metallization,

and/or

that the at least one base layer made of silicon nitride ceramic is provided with at least one intermediate layer on each of the surface sides,

and/or

that at least one metallization is applied to each of the intermediate layers,

and/or

that the ceramic material is formed symmetrically to a central plane running parallel to the surface sides of the ceramic material, in relation to the layer sequence and thickness of the ceramic layers,

and/or

that it is formed symmetrically to a central plane running parallel to the surface sides of the substrate, in relation to the layer sequence and/or in relation to the thickness of the layers, including the thickness of the intermediate layers and metallizations.

In addition, the material used for the at least one intermediate layer preferably has a modulus of elasticity of under 300 GPa, particularly a modulus of elasticity within the range 100 to 300 GPa,

and preferably that the thickness of the at least one intermediate layer is significantly less than the thickness (dc) of the silicon nitride ceramic base layer carrying this intermediate layer or is significantly less than the thickness (dm) of the at least one metallization.

Additionally, the thickness (dm) of the at least one metallization is preferably at most equal to three times the thickness (dc) of the silicon nitride ceramic base layer,

and

that the thickness of the at least one intermediate layer falls within the range 0.1-10 μm,

and

that the thickness (dc) of the at least one silicon nitride ceramic base layer falls within the range 0.1 to 2 mm,

and

that the thickness (dm) of the at least one metallization falls within the range 0.5-1 mm.

The at least one copper metallization is made of a copper alloy,

and

that the base layer or the at least one intermediate layer contains sintering aids, particularly in the form of at least one rare earth element.

The ceramic of the at least one intermediate layer contains as a sintering aid an oxide of Ho, Er, Yb, Y, La, Sc, Pr, Ce, Nd, Dy, Sm, Gd or mixtures of at least two of these oxides,

and

that the proportion of sintering aids is within the range 1.0 to 8.0% by wt.

Further, that the at least one intermediate layer contains as the additional component at least one oxidic constituent from the group Li₂O, TiO₂, BaO, ZnO, B₂O₃, CsO, Fe₂O₃, ZrO₂, CuO, Cu₂O, in which case the proportion of this additional component is maximum 20% by wt. relative to the total mass of the intermediate layer.

The at least one base layer made of silicon nitride ceramic exhibits a thermal conductivity greater than 45 W/mK,

and

that the adhesion or peel strength of the at least one metallization on the ceramic material is greater than 40 N/cm.

Between the at least one intermediate layer and the adjacent metallization at least one further layer of a brazing solder is provided,

and

the brazing solder consists of a basic component suitable as solder and an active metal, for example Ti, Hf, Zr, Nb and/or Ce.

Additionally, the outer dimensions of the substrate are greater than 80×80 mm, preferably greater than 100×150 mm,

in which case the aforementioned features of the substrate can each be provided individually or in any combination.

In a further development of the invention, the method is executed, for example, in such a manner

that a layer made of zirconium oxide or a silicate layer is applied as the intermediate layer, the thermal coefficient of expansion of which is smaller than or, at most, equal to 6×10⁻⁶ K⁻¹ and in which the proportion of free silicon (SiO₂) is negligibly small, at least close to the bond between the intermediate layer (6, 7) and the metallization or at the transition between the intermediate layer and the metallization.

The intermediate layer is formed in such a manner that the proportion of free silicon oxide (SiO₂) in the at least one intermediate layer, at least close to the bond between the intermediate layer and the metallization or at the transition between the intermediate layer and the metallization, is equal to or almost equal to zero.

The at least one base layer is provided with an intermediate layer on each of the two surface sides and at least one metallization is applied to each of the intermediate layers.

The intermediate layer is produced with a thickness that is significantly less than the thickness (dc) of the base layer or significantly less than the thickness (dm) of the at least one metallization.

A metal foil with a thickness (dm) that is, at most, equal to three times the thickness (dc) of the base layer is used for the at least one metallization.

Further, the at least one intermediate layer is produced with a thickness within the range 0.1-10 μm.

A material is used for the base layer or for the at least one intermediate layer, which contains at least one sintering aid, particularly in the form of at least one rare earth element, wherein the proportion of sintering aids falls particularly within the range 1.0 to 8.0% by wt.

Preferably, a material is used for the at least one intermediate layer, which contains at least one oxidic constituent from the group Li₂O, TiO₂, BaO, ZnO, B₂O₃, CsO, Fe₂O₃, ZrO₂, CuO, Cu₂O as the additional component, wherein the proportion of the additional component is a maximum of 20% by wt. relative to the total mass of the intermediate layer.

The base layer is coated on at least one surface side with a material forming the intermediate layer and this coating is burnt in or densely sintered at a temperature within the range 1200 to 1680° C.,

and that the burning-in or dense-sintering takes place in an oxidic atmosphere.

The coating takes place by spraying, dipping, for example from aqueous dispersions, or in a sol-gel process,

and

the coating involves the use of micro- to nano-dispersed mixtures containing the zirconium oxide and/or the at least one silicate,

wherein the aforementioned features of the process can in turn each be used individually or in any combination.

### BRIEF DESCRIPTION OF THE FIGURES

Further developments, advantages and possible applications of the invention also result from the following description of exemplary embodiments and from the figures.

FIG. 1 shows a simplified representation of a section through a substrate according to the invention;

FIG. 2 shows a schematic representation of a method of determining the adhesion or peel strength of a metallization formed from a foil and applied to the ceramic material;

FIG. 3 shows the distribution of free silicon oxide (SiO₂) in the intermediate layer made of zirconium oxide and/or at least one silicate in a graph; and

FIG. 4 shows in a similar representation to FIG. 1, a further possible embodiment of the substrate according to the invention.

### DETAILED DESCRIPTION OF THE INVENTION

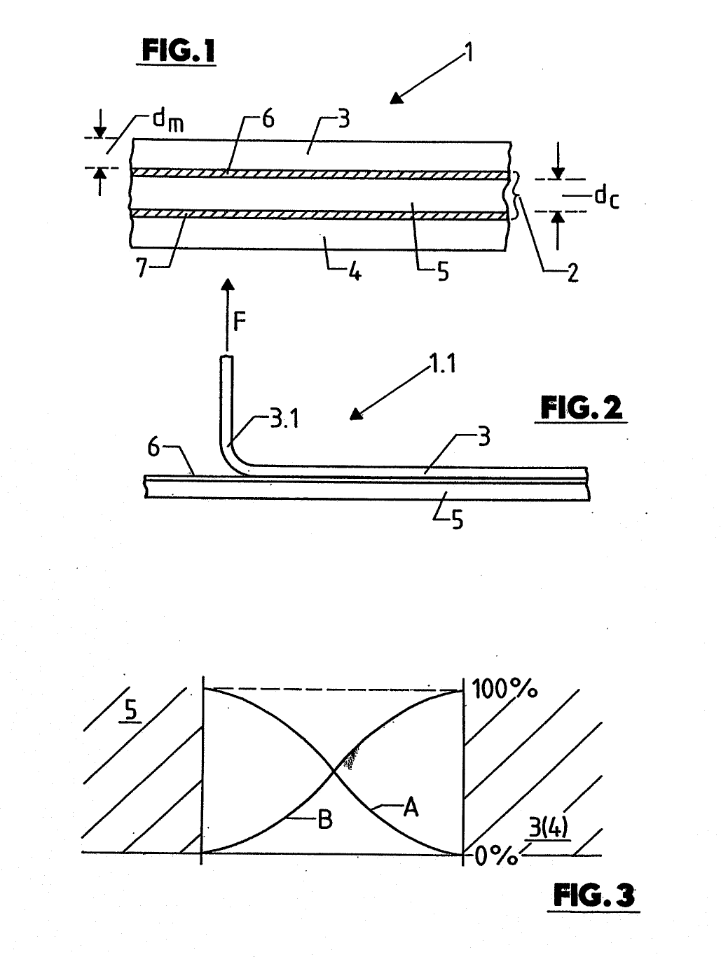

The metal/ceramic substrate generally denoted as 1 in FIG. 1 consists of a plate-shaped ceramic material 2, which is provided with a metallization 3 or 4 provided by a metal foil, i.e. in the embodiment shown, by a copper foil, with a thickness dm on each of the two surface sides using the DCB method. The ceramic material 2 is executed in multiple layers comprising an inner ceramic or base layer 5 made of silicon nitride (Si₃N₄), which is provided with an intermediate layer 6 or 7 made of zirconium oxide or at least one silicate on each of the two surface sides, so that application of the metallizations 3 and 4 to the ceramic material 2 is possible using the DCB method without defects and with high adhesive strength of the copper forming the metallizations 3 and 4.

The base layer 5 has a thickness dc and also contains sintering aids in the form of an oxide of Ho, Er, Yb, Y, La, Sc, Pr, Ce, Nd, Dy, Sm and/or Gd, among others. Combinations of one or more of these oxides are also possible as sintering aids, in which case Ho₂O₃ or Er₂O₃ are used in particular. The proportion of sintering aids in the middle layer 5 falls within the range 1 to 8% by wt. relative to the total mass of the ceramic forming the base layer 5.

In the case of the embodiment shown, the two metallizations 3 and 4 have the same thickness dm, which may be no more than three times the thickness dc. However, the thickness of the metallizations 3 and 4 is usually within the range 0.1 to 1 mm. The thickness dc falls within the range between 0.1 and 2 mm.

The intermediate layers 6 and 7, which are far thinner compared with the base layer 5 and the metallizations 3 and 4 and have a thickness within the range 0.1 to 10 mμ, for example, are made of zirconium oxide or at least one silicate, in which case the intermediate layer 6 or 7 in each case exhibits no free silicon oxide (SiO₂) or the proportion of free SiO₂, at least in the areas of the intermediate layer 6 and 7 adjacent to these metallizations 3 and 4, is negligibly small.

Apart from zirconium oxide, zirconium silicate, titanium silicate or hafnium silicate, in particular, are also suitable for the intermediate layers 6 and 7, are silicates with a thermal coefficient of expansion that is smaller than or, at most, equal to 6×10⁻⁶ K⁻¹. On the other hand, the thermal coefficient of expansion of aluminium oxide (Al₂O₃) is 8×10⁻⁶ K⁻¹.

Mixtures of several of the aforementioned materials are also suitable for the intermediate layers 6 and 7, in each case, however, a modulus of elasticity for the intermediate layers that is less than or, at most, equal to 300 GPa is preferably aimed at, so that a certain balance between the very different thermal coefficients of expansion between the metal or copper of the metallizations 3 and 4 and the Si₃N₄ of the internal layer 5 can thereby be achieved via the respective intermediate layer 6 or 7.

Using the aforementioned materials for the intermediate layers 6 and 7, this requirement can also be optimally met in relation to the expansion behaviour or elasticity of the intermediate layers.

The intermediate layers 6 and 7 preferably contain, as explained, one or more additives from the group LiO₂, TiO₂, BaO, ZO, B₂, O₃, CsO, Fi₂O₃, ZrO₂, CuO, Cu₂O as the additional component, specifically up to a maximum proportion of 20% by wt. relative to the mass of the intermediate layer concerned.

During production of the substrate 1, a plate made of silicon nitride ceramic (Si₃N₄ ceramic) forming the base layer 5 is used as the basic material. This is then coated on both sides using a suitable method to form the intermediate layer 6 or 7 in each case using the component(s) suitable for the intermediate layer.

Different techniques are available for this coating, in which the material forming the intermediate layer in each case is mixed with a suitable liquid, such as water, and deposited on the surface sides of the plate-shaped basic material. After this, the respective intermediate layer 6 or 7 is burnt in and densely sintered at a temperature within the range 1200 to 1680° C. in an oxidic atmosphere after previous drying.

The coating of the basic material involves using micro- to nano-dispersed mixtures containing the material of the intermediate layer 6 or 7, e.g. by spraying, dipping (dipcoating or spincoating) from aqueous dispersions. Other methods can also be used, for example sol-gel processes.

Once the intermediate layers 6 and 7 have been applied, the bonding or application of the metal or copper foils forming the metallizations 3 and 4 is carried out using the known DCB method.

The substrate 1 may be produced on a large-scale with dimensions greater than 80×80 mm, preferably greater than 100×150 mm, so that the production of a multiplicity of individual substrates is possible with the substrate 1 by further processing, i.e. by structuring the metallizations 3 and 4 accordingly in multiple use.

The substrate 1 with the structure described has an improved mechanical strength, specifically due to the base layer 5 made of a silicon nitride ceramic. Furthermore, the bonding of the metallizations 3 and 4 with the established DCB method using the customary process is possible, namely without the risk of defects in the bond between the metallizations 3 and 4 and the ceramic material 2, which (defects) severely affect the adhesion of metallizations to the ceramic material and can also cause the electrical strength of the substrate to be detrimentally affected.

In the case of the substrate 1 with the structure described earlier, a sufficiently high adhesion of the metallizations to the ceramic material 2 is achieved. This adhesion or peel strength is measured using the method shown in FIG. 2. A test specimen 1.1, which matches the substrate 1 in terms of its design, but only with the metallization 3 and the intermediate layer 6, is produced in the manner described earlier, whereby the metallization 3 is produced as a strip with a width of 1 cm and a thickness dm of 0.3 mm. A force F is exerted on the upward-pointing end 3.1 of the strip-shaped metallization with the test specimen 1.1 clamped, this being of such a magnitude that the strip-shaped metallization 3 is removed from the ceramic material 2 at a speed of 0.5 cm/min. The force F required for this then determines the adhesion or peel strength. This is greater than 40 N/cm in the case of the substrate 1 with the design described earlier.

The graph in FIG. 3 shows the distribution (curve A) of the free silicon oxide (SiO₂) in the intermediate layer 6 and 7, namely starting from the inner layer 5 up to the metallization 3 or 4. As suggested by curve A, the proportion of free SiO₂ falls sharply relative to the proportion of zirconium oxide and/or silicate forming the intermediate layer up to the respective metallization 3 or 4, in which case the proportion of free SiO₂ close to the metallization falls to 0% by wt., namely relative to the total mass of the intermediate layer. The course of the share of zirconium oxide or silicate forming the intermediate layer, possibly with the aforementioned additives, is depicted by curve B in FIG. 3.

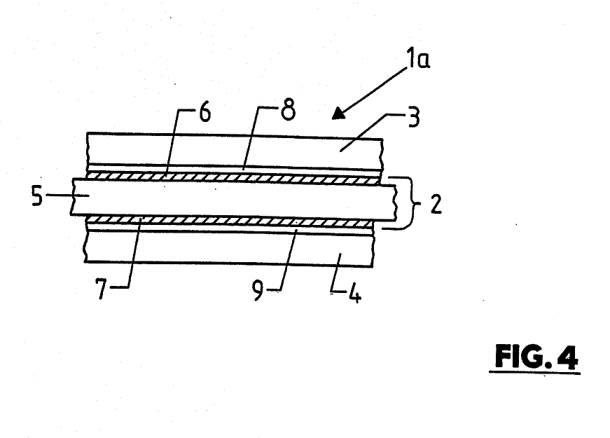

FIG. 4 shows a further possible embodiment in a depiction similar to FIG. 1 as a substrate 1a, which differs from the substrate 1 in that the metallizations 3 and 4 are not applied to the ceramic material 2 by the DCB method, but using the reactive brazing process. This involves a layer 8 or 9 of brazing solder being applied to the ceramic material, which in turn consists of the base layer 5 of the Si₃N₄ ceramic and the two intermediate layers 6 and 7, across which the respective metallization or the metal or copper foil forming this metallization is bonded two-dimensionally with the ceramic material 2.

The materials customarily used, e.g. a brazing solder containing a basic component or a solder constituent, such as copper and silver, and an active component, such as Ti, Hf, Zr, are suitable as reactive brazing solder. Production of the substrate 1a in turn takes place in such a manner that the ceramic material 2 is initially produced in one or several previous procedures. Following this, application of the metallizations 3 and 4 takes place using the known reactive brazing technique, in which the layers 8 and 9 of reactive brazing solder are applied either as a paste or as a foil.

For the production of strip conductors, contact faces, etc., the metal/ceramic substrates are structured in the usual manner using the customary technique, e.g. with the known masking and etching technology.

The invention was described earlier using exemplary embodiments. It goes without saying that numerous changes and adjustments are possible, without thereby departing from the basic idea underlying the invention.

### REFERENCE LIST

1, 1a Metal/ceramic substrate
1.1 Test specimen
2 Ceramic material
3, 4 Metallization
5 Inner layer of silicon nitride ceramic
5, 6 Intermediate layer of an oxidic ceramic
8, 9 Reactive brazing layer
F Pull-off strength
dc Thickness of the inner layer of silicon nitride ceramic
dm Thickness of the metal layers forming the metallizations

1. A metal/ceramic substrate comprising a multilayer, plate-shaped ceramic material and at least one metallization provided on a surface side of the ceramic material, the at least one metallization is bonded to the ceramic material by direct bonding method or reactive brazing, wherein the ceramic material comprises at least one base layer made of a silicon nitride ceramic and wherein the surface side of the ceramic material provided with the at least one metallization is formed from at least one intermediate layer of an oxidic ceramic applied to the at least one base layer, the at least one intermediate layer is a zirconium oxide layer or a silicate layer.

2. The substrate according to claim 1, wherein silicate in the silicate layer is a zirconium silicate, a titanium silicate or a hafnium silicate.

3. The substrate according to claim 1, wherein the at least one intermediate layer has a thermal coefficient of expansion that is smaller than or, at most, equal to 6×10⁻⁶K⁻¹.

4. The substrate according to claim 1, wherein a proportion of free silicon oxide (SiO₂) in the at least one intermediate layer, near a bond between the at least one intermediate layer and the at least one metallization is negligibly small.

5. The substrate according to claim 1, wherein a proportion of free silicon oxide in the at least one intermediate layer in the area of the bond between the at least one intermediate layer and the at least one metallization is equal to or close to zero.

6. The substrate according to claim 1, wherein the at least one base layer made of silicon nitride ceramic is provided with at least one intermediate layer on each surface sides of the at least one base layer.

7. The substrate according to claim 6, wherein the at least one metallization is applied to the at least one intermediate layer.

8. The substrate according to claim 1, wherein the ceramic material is formed symmetrically to a central plane running parallel to surface sides of the ceramic material, in relation to a layer sequence and a thickness of the at least one base layer and the at least one intermediate layer.

9. The substrate according to claim 1, wherein the substrate is formed symmetrically to a central plane running parallel to surface sides of the substrate, in relation to a layer sequence or in relation to a thickness of the at least one intermediate layers and the at least one metallization.

10. The substrate according to claim 1, wherein a material used for the at least one intermediate layer has a modulus of elasticity of under 300 GPa or within the range 100 to 300 GPa.

11. The substrate according to claim 1, wherein a thickness of the at least one intermediate layer is less than a thickness of the at least one base layer or is less than a thickness of the at least one metallization.

12. The substrate according to claim 1, wherein a thickness of the at least one metallization is at most equal to three times a thickness of the at least one base layer.

13. The substrate according to claim 1, wherein a thickness of the at least one intermediate layer falls within the range 0.1-10 μm.

14. The substrate according to claim 1, wherein a thickness of the at least one base layer falls within the range 0.1 to 2 mm.

15. The substrate according to claim 1, wherein a thickness of the at least one metallization falls within the range 0.5-1 mm.

16. The substrate according to claim 1, wherein the at least one metallization is made of a copper alloy.

17. The substrate according to claim 1, wherein the at least one base layer or the at least one intermediate layer contains sintering aids in the form of at least one rare earth element.

18. The substrate according to claim 17, wherein the at least one intermediate layer contains as a sintering aid an oxide of Ho, Er, Yb, Y, La, Sc, Pr, Ce, Nd, Dy, Sm, Gd or mixtures of at least two of the oxides.

19. The substrate according to claim 17, wherein a proportion of sintering aids in the at least one base layer or the at least one intermediate layer is within the range 1.0 to 8.0% by wt.

20. The substrate according to claim 1, wherein the at least one intermediate layer contains as an additional component at least one oxidic constituent from Li₂O, TiO₂, BaO, ZnO, B₂O₃, CsO, Fe₂O₃, ZrO₂, CuO or Cu₂O, a proportion of this additional component in the at least one intermediate layer is a maximum of 20% by wt.

21. The substrate according to claim 1, wherein the at least one base layer made of silicon nitride ceramic exhibits a thermal conductivity greater than 45 W/mK.

22. The substrate according to claim 1, wherein an adhesion or peel strength of the at least one metallization on the ceramic material is greater than 40 N/cm.

23. The substrate according to claim 1, wherein a further layer of a brazing solder is provided between the at least one intermediate layer and the metallization.

24. The substrate according to claim 23, wherein the brazing solder comprises solder component and an active metal selected from the group consisting of Ti, Hf, Zr, Nb and Ce.

25. The substrate according to claim 1, wherein outer dimensions of the substrate are greater than 80×80 mm.

26. A method of producing a metal/ceramic substrate with a multilayer, plate-shaped ceramic material comprising at least one base layer made of a silicon nitride ceramic and at least one metallization provided on a surface side of the ceramic material, wherein an intermediate layer is formed on a surface side of the base layer to be provided with the at least one metallization and the at least one metallization is applied to the intermediate layer by direct bonding or reactive brazing of at least one metal layer, wherein
a zirconium oxide layer or a silicate layer is used for the intermediate layer.

27. The method according to claim 26, wherein the intermediate layer has a thermal coefficient of expansion which is smaller than or, at most, equal to 6×10⁻⁶ K⁻¹ and a proportion of free silicon (SiO₂) near to a bond between the intermediate layer and the metallization or at a transition between the intermediate layer and the metallization is negligibly small.

28. The method according to claim 27, wherein the intermediate layer is formed in such a manner that a proportion of free silicon oxide (SiO₂) in the at least one intermediate layer close to a bond between the intermediate layer and the at least one metallization or at the transition between the intermediate layer and the at least one metallization, is equal to or almost equal to zero.

29. The method according to claim 27, wherein the at least one base layer is provided with an intermediate layer on each of two surface sides of the at least one base layer and the at least one metallization is applied to each of the intermediate layers.

30. The method according to claim 26, wherein the intermediate layer is produced with a thickness that is less than a thickness of the at least one base layer or less than a thickness of the at least one metallization.

31. The method according to claim 26, wherein a metal foil with a thickness that is, at most, equal to three times a thickness of the at least one base layer is used for the at least one metallization.

32. The method according to claim 26, wherein the intermediate layer is produced with a thickness within the range 0.1-10 μm.

33. The method according to claim 26, wherein a material is used for the at least one base layer or for the intermediate layer, which contains at least one sintering aid, in the form of at least one rare earth element, and wherein a proportion of the at least one sintering aid within the range 1.0 to 8.0% by wt.

34. The method according to claim 26, wherein a material is used for the intermediate layer, which contains at least one oxidic constituent from the group Li₂O, TiO₂, BaO, ZnO, B₂O₃, CsO, Fe₂O₃, ZrO₂, CuO or Cu₂O as an additional component, and wherein a proportion of the additional component is a maximum of 20% by wt. relative to a total mass of the intermediate layer.

35. The method according to claim 26, wherein the at least one base layer is coated on at least one surface side with a material forming the intermediate layer and the coating is burnt in or densely sintered at a temperature within the range 1200° C. to 1680° C.

36. The method according to claim 35, wherein the burning-in or dense-sintering takes place in an oxidic atmosphere.

37. The method according to claim 35, wherein the coating takes place by spraying or dipping.

38. The method according to claim 35, wherein the coating involves use of micro- to nano-dispersed mixtures containing a zirconium oxide or at least one silicate.
